(19) United States
(12) Patent Application Publication
(10) Pub. No.: US 2015/0028134 A1
(43) Pub. Date: Jan. 29, 2015

(54) Gardening Gun Structure

(71) Applicant: Chen-Fu HUNG, Changhua (TW)

(72) Inventor: Chen-Fu HUNG, Changhua (TW)

(73) Assignee: RUEY RYH ENTERPRISE CO., LTD., CHANGHUA (TW)

(21) Appl. No.: 13/948,979

(22) Filed: Jul. 23, 2013

(51) Int. Cl. B05B 9/01; B05B 12/00

(52) U.S. Cl. CPC B05B 9/01; B05B 12/002
USPC 239/526

(57) ABSTRACT

A gardening gun structure may include a water gun body with an extended handle; a pull grip pivotally connected to a rear side of the handle; and a water controlling shaft set comprising a water controlling shaft, a water stoppage ring and a water controlling head being disposed at an end of the water controlling shaft, and a screw thread section being disposed at another end, a spring being sleeved around a shaft section disposed at an inner end of the water controlling head, a water stoppage pad with a central hole being sleeved around a shaft section disposed at a rear end of the spring, a first bush being sleeved around a shaft section between the spring and the water stoppage pad, and a second bush being sleeved around a shaft section disposed at a rear end of the water stoppage pad.

### BACKGROUND OF THE INVENTION

1. Field of Invention

The present invention relates to a gardening gun structure and more particularly to a gardening gun structure disposed with an internal water controlling shaft set and a water stoppage pad sleeved around a water controlling shaft for enhancing the effectiveness and durability of the gardening gun by avoid leakage of the gardening gun.

2. Related Art

FIGS. 1, 2 and 3 show a perspective view, an exploded perspective view and a cross sectional assembly view of a conventional gardening gun structure respectively. The conventional gardening gun structure comprising a water gun body 10 with a horizontal water controlling passage 11 being disposed inside the water gun body 10, a small diameter water outlet 111 connecting with a nozzle 113 being formed at a front central end of the water controlling passage 11, a through hole 112 penetrating from a read end of the water gun body 10 being formed at a rear central end of the water controlling passage 11; a pull grip 12 pivotally connected to the read end of the water gun body 10, a sleeve hole 121 disposed on an upper end of the pull grip 12 being corresponded to the through hole 112 disposed at the read end of the water gun body 10; and a water controlling shaft 13, a water stoppage ring 131 and a water controlling head 132 being disposed at an end of the water controlling shaft 13 in order to form a water controlling end, and a screw thread section 133 being disposed at another end, a spring 134 being sleeved around a shaft section disposed at an inner end of the water controlling head 132, a rubber water stoppage pad 135 with a central hole being sleeved around the water controlling shaft 13 disposed at a rear end of the spring 134. The water controlling end is inserted inside the water controlling passage 11 with the water stoppage ring 131 and the water controlling head 132 corresponding to the small diameter water outlet 111 of the water gun body 10; and the screw thread section 133 is penetrated outside from the through hole 112 at the rear end of the water controlling passage 11 and the sleeve hole 121 of the pull grip 12, and screwed with an adjusting nut 136. Thereby, the water controlling shaft 13 is combined inside the water controlling passage 11 of the water gun body 10 and pulled backwardly by the pull grip 12 and returned forwardly in order to control the discharging of water.

In the cross sectional assembly view of the conventional gardening gun structure in FIG. 3, the control of water discharge is achieved by pulling the water controlling shaft 13 by the pull grip 12 and is restored by the elasticity of the spring 134. The water stoppage pad 135 is pressed tightly against an inner side of the through hole 112 in order to prevent water from leaking from the through hole 112 of the water gun body 10.

### SUMMARY OF THE INVENTION

However, an end of the spring 134 for pushing against the water stoppage pad 135 is a metal wire coil structure, the contact area between the water stoppage pad 135 and the spring 134 is relatively small. Therefore, the water stoppage pad 135 can be easily damaged by the destructive pressure and shearing force of the end of the spring 134. As a result, the first drawback is that water leakage will occur easily in the gardening gun, which will cause trouble and inconvenience during usage.

Furthermore, the second drawback of the conventional gardening gun structure is that the gardening gun with the easily-damaged water stoppage pad 135 is less durable.

Therefore, a gardening gun structure of the present invention provides a water stoppage pad and a water controlling shaft set to solve the drawbacks of easy water leaking and low durability in the conventional gardening gun structure.

A primary objective of the present invention is to provide a gardening gun structure disposed with an internal water controlling shaft set for preventing a water stoppage pad from being damaged easily and providing better protection against leakage to enhance the effectiveness and quality of the gardening gun structure.

A secondary objective of the present invention is to provide a gardening gun structure disposed with an internal water controlling shaft set for preventing a water stoppage pad from being damaged easily in order to enhance the durability of the gardening gun structure.

The gardening gun structure of the present invention comprising:
a water gun body of a water gun structure with an extended handle, a horizontal water controlling passage being disposed inside the water gun body, a small diameter water outlet connecting with a nozzle being formed at a front central end of the water controlling passage, a through hole penetrating from a rear end of the water gun body being formed at a rear central end of the water controlling passage;
a pull grip pivotally connected to a rear side of the handle, a sleeve hole disposed on an upper end of the pull grip being corresponded to the through hole at the rear end of the water gun body; and
a water controlling shaft set comprising a water controlling shaft, a water stoppage ring and a water controlling head being disposed at an end of the water controlling shaft, and a screw thread section being disposed at another end, a spring being sleeved around a shaft section disposed at an inner end of the water controlling head, a water stoppage pad with a central hole being sleeved around a shaft section disposed at a rear end of the spring, a first bush being sleeved around a shaft section between the spring and the water stoppage pad, a second bush being sleeved around a shaft section disposed at a rear end of the water stoppage pad. The water controlling shaft is inserted inside the water controlling passage with the water stoppage ring corresponding to the small diameter water outlet of the water gun body; and the screw thread section is penetrated outside from the through hole at the rear end of the water controlling passage and the sleeve hole of the pull grip, and screwed with an adjusting nut.

The water controlling head of the water controlling shaft is disposed with four outwardly protruding flaps.

The first bush is a sleeve body disposed between the water controlling shaft and the spring, and a stoppage flange for pressing against the end of the spring is protrudingly disposed from an outer circumference of an end of the first bush corresponded to the water stoppage pad.

The present invention will become more fully understood by reference to the following detailed description thereof when read in conjunction with the attached drawings.

### BRIEF DESCRIPTION OF THE DRAWINGS

FIG. 1 is a perspective view of a conventional gardening gun structure;

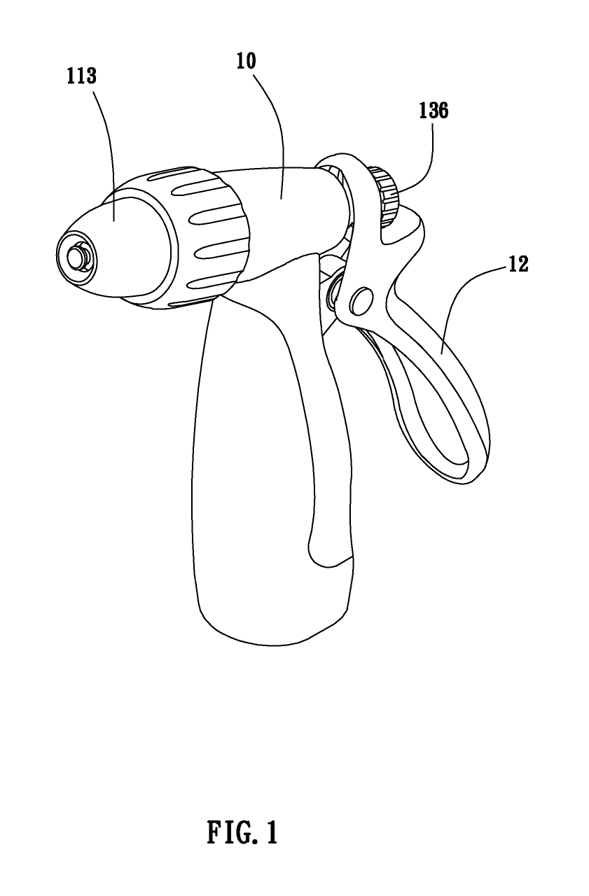

FIG. 2 is an exploded perspective view of the conventional gardening gun structure;

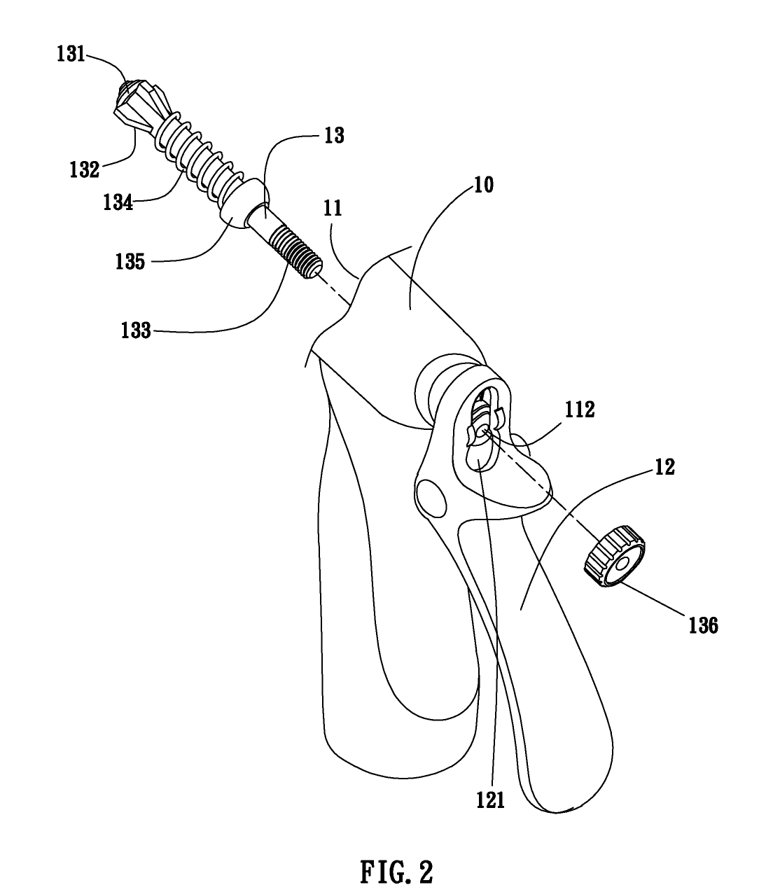

FIG. 3 is a cross sectional assembly view of the conventional gardening gun structure;

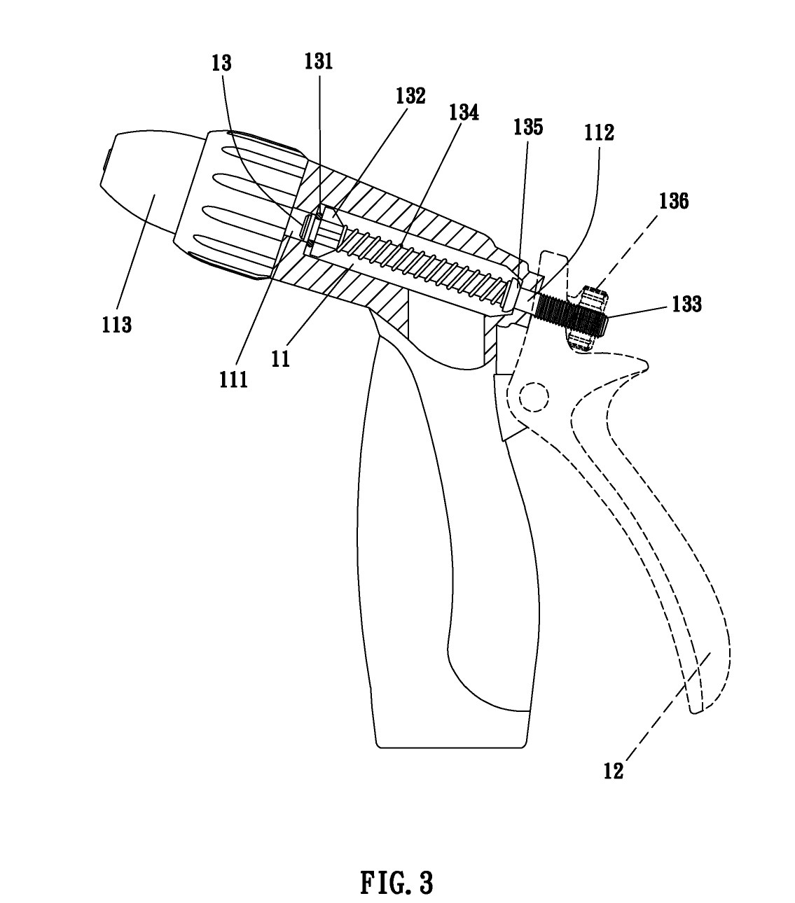

FIG. 4 is a perspective view of a gardening gun structure of the present invention;

FIG. 5 is an exploded perspective view of the gardening gun structure of the present invention; and

FIG. 6 is a cross sectional assembly view of the gardening gun structure of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

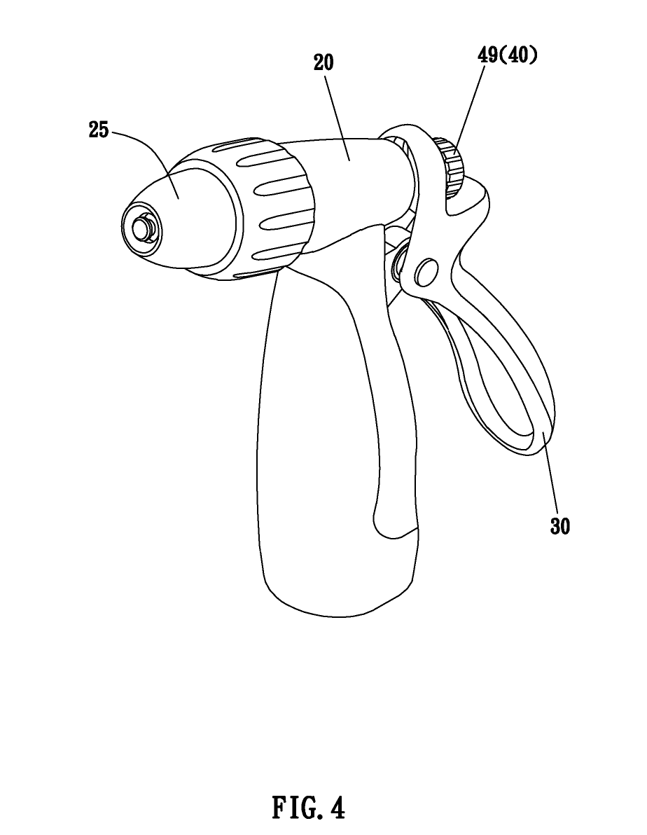

Please refer to FIGS. 4, 5 and 6. FIGS. 4, 5 and 6 show a perspective view, an exploded perspective view and a cross sectional assembly view of a gardening gun structure of the present invention respectively. The gardening gun structure may include a water gun body 20, a pull grip 30 and a water controlling shaft set 40.

The water gun body 20 is a water gun structure with an extended handle 21. A horizontal water controlling passage 22 is disposed inside the water gun body 20. A small diameter water outlet 23 connecting with a nozzle 25 is formed at a front central end of the water controlling passage 22. A through hole 24 penetrating from a rear end of the water gun body 20 is formed at a rear central end of the water controlling passage 22.

A pull grip 30 is pivotally connected to a rear side of the handle 21. A sleeve hole 31 disposed on an upper end of the pull grip 30 is corresponding to the through hole 24 at the rear end of the water gun body 20.

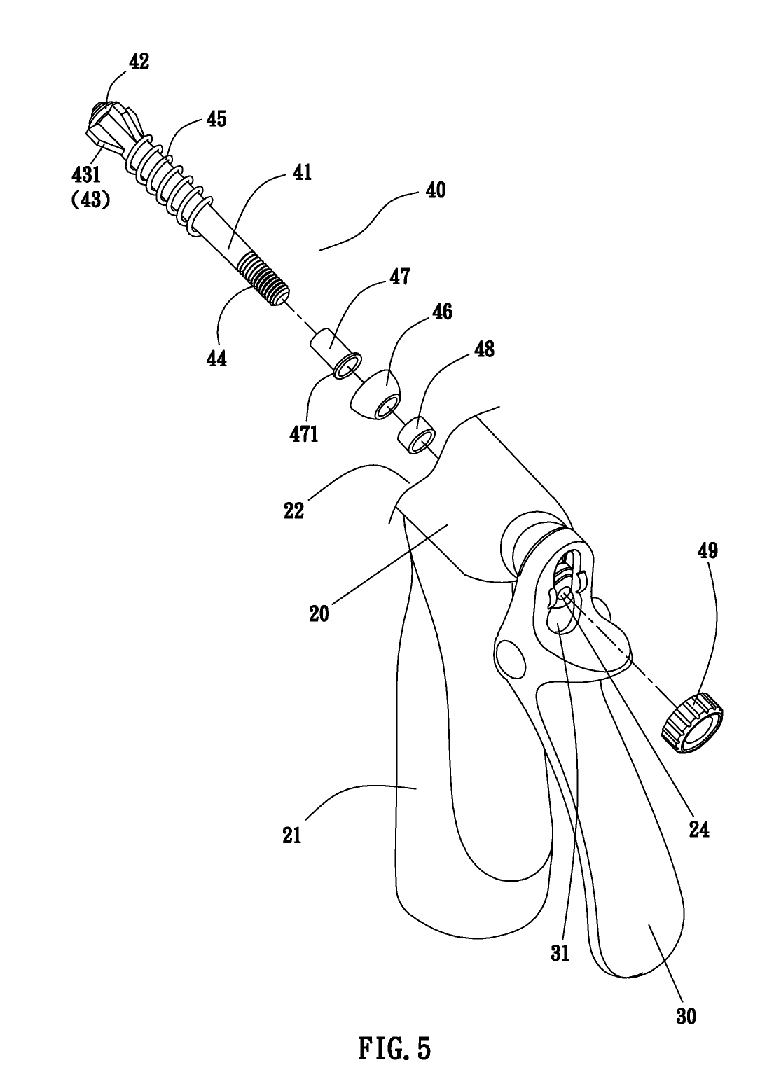

A water controlling shaft set 40 comprises a water controlling shaft 41, a water stoppage ring 42, a water controlling head 43 with four outwardly protruding flaps 431 disposed at an end of the water controlling shaft 41, and a screw thread section 44 is disposed at another end. A spring 45 is sleeved around a shaft section disposed at an inner end of the water controlling head 43. A water stoppage pad 46 with a central hole is sleeved around a shaft section disposed at a rear end of the spring 45. A first bush 47 is sleeved around a shaft section between the spring 45 and the water stoppage pad 46. A second bush 48 is sleeved around a shaft section disposed at a rear end of the water stoppage pad 46. The first bush 47 is a sleeve body disposed between the water controlling shaft 41 and the spring 45, and a stoppage flange 471 for pressing against the end of the spring 45 is protrudingly disposed from an outer circumference of an end of the first bush 47 corresponded to the water stoppage pad 46. The water controlling shaft 41 is inserted inside the water controlling passage 22 with the water stoppage ring 42 corresponding to the small diameter water outlet 23 of the water gun body 20; and the screw thread section 44 is penetrated outside from the through hole 24 at the rear end of the water controlling passage 22 and the sleeve hole 31 of the pull grip 30 as shown in FIG. 5, and screwed with an adjusting nut 49. Thereby, the control of water discharge is achieved by pulling the water controlling shaft 41 through the pull grip 30, and the water controlling shaft 41 can be restored by the elasticity of the spring 45.

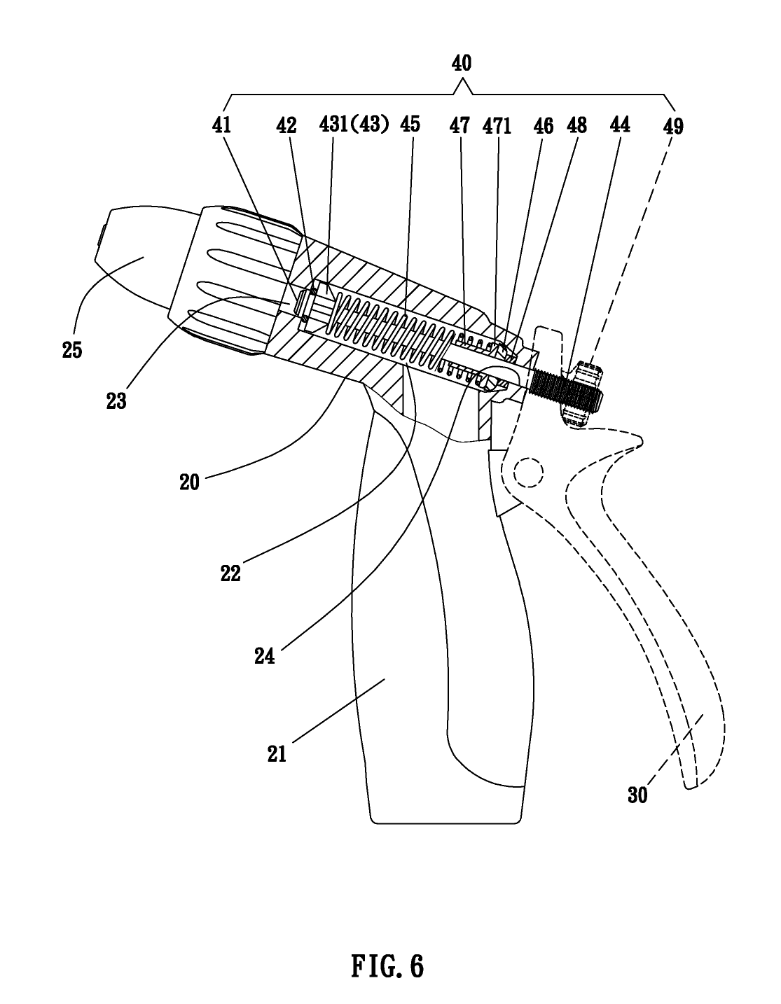

As shown in the cross sectional assembly view of the gardening gun structure of the present invention in FIG. 6, when the water controlling shaft 41 is pulled by the pull grip 30 and the water controlling shaft 41 is restored by the elasticity of the spring 45; the stoppage flange 471 protrudingly disposed from the outer circumference of the end of the first bush 47 being pressed against between the spring 45 and the water stoppage pad 46 has a larger contact area with the water stoppage pad 46, and the destructive pressure and shearing force formed by the smaller contact area of the end of the spring 45 is blocked. Furthermore, the second bush 48 disposed at the rear end of the water stoppage pad 46 also provides the same protection effect.

Therefore, by sleeving the first bush 47 and the second bush 48 against the front and rear ends of the water stoppage pad 46, the water stoppage pad 46 can be provided with better protection effect against damage, and the water gun body 20 can effectively avoid water leaking during usage to provide better effectiveness and quality of the gardening gun.

According to the above mentioned, by employing the gardening gun structure disposed with the internal water controlling shaft set and the water stoppage pad sleeved around the water controlling shaft, the gardening gun can be prevented from leaking water during usage, and the effectiveness and durability of the gardening gun can be enhanced.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A gardening gun structure, comprising:
a water gun body of a water gun structure with an extended handle, a horizontal water controlling passage being disposed inside the water gun body, a small diameter water outlet connecting with a nozzle disposed at a front central end of the water controlling passage, and a through hole penetrating from the water gun body disposed at a rear central end of the water controlling passage;
a pull grip pivotally connected to a rear side of the handle, and a sleeve hole disposed on an upper end of the pull grip being corresponding to the through hole at a rear end of the water gun body; and
a water controlling shaft set comprising a water controlling shaft, a water stoppage ring and a water controlling head being disposed at an end of the water controlling shaft, a screw thread section being disposed at another end, a spring being sleeved around a shaft section disposed at an inner end of the water controlling head, a water stoppage pad with a central hole being sleeved around a shaft section disposed at a rear end of the spring, a first bush being sleeved around a shaft section between the spring and the water stoppage pad, and a second bush being sleeved around a shaft section disposed at a rear end of the water stoppage pad, wherein the water controlling shaft is inserted inside the water controlling passage with the water stoppage ring corresponding to the small diameter water outlet of the water gun body; and the screw thread section is penetrated outside from the through hole at the rear end of the water controlling passage and the sleeve hole of the pull grip, and screwed with an adjusting nut.

2. The gardening gun structure as claimed in claim 1, wherein the water controlling head of the water controlling shaft is disposed with four outwardly protruding flaps.

3. The gardening gun structure as claimed in claim 2, wherein the first bush is a sleeve body disposed between the water controlling shaft and the spring, and a stoppage flange for pressing against the end of the spring is protrudingly disposed from an outer circumference of an end of the first bush corresponding to the water stoppage pad.
